(19) United States
(12) Patent Application Publication
(10) Pub. No.: US 2009/0025794 A1
(43) Pub. Date: Jan. 29, 2009

(54) ULTRA LOW VOLUME FLUID DELIVERY SYSTEM USING A CENTRIFUGAL RADIAL COMPRESSOR AND METHOD THEREOF

(76) Inventors: Bruce Dorendorf, Winnebago, MN (US); Larry D. Heller, Osteen, FL (US); John T. Douglas, Lake Mary, FL (US)

Correspondence Address: DOBRUSIN & THENNISCH PC, 29 W LAWRENCE ST, SUITE 210, PONTIAC, MI, 48342, US

(21) Appl. No.: 12/134,749

(22) Filed: Jun. 6, 2008

Related U.S. Application Data
(60) Provisional application No. 60/942,732, filed on Jun. 8, 2007.

(51) Int. Cl. E03B 5/00; B67D 5/52

(52) U.S. Cl. 137/1; 137/565.17; 137/565.29

(57) ABSTRACT

A fluid delivery system and method is disclosed for the application of fluids to a region using a centrifugal radial compressor.

### PRIORITY

The present invention claims priority to provisional patent application 60/942,732, filed on Jun. 8, 2007, the contents of which are entirely incorporated by reference for all purposes.

### FIELD OF INVENTION

The present invention relates generally to improved devices, systems, and methods for applying fluids, liquids, and atomized liquid/gas to desired regions and more particularly to devices, systems, and methods adapted for applying fluids, liquids, and atomized liquid/gas and using a radial compressor. It is contemplated that the present invention would provide increased utility, improvements, and enhanced operational and cost efficiencies spraying, dissemination, and application of fluids, liquids, and atomized liquid/gas mixtures for a number of purposes such as: insect control/eradication, agricultural spraying and enhancement of fruit, citrus, vegetable, horticultural, and the growing of other agricultural or commodities, pesticide applications, medicinal or medical product spraying applications, including spraying antibiotics among livestock, chickens, pigs, etc., antidotes for potential terrorist activities, herbicide applications, insecticide applications, paint applications, misting applications, cooling applications, water applications, fertilizer applications, law enforcement and crowd control applications, solid-stream applications, and application of cleaning/stripping/degreasing solutions for household and industrial uses. More particularly, the present invention relates to a device that generates low noise, is a cost effective, low-maintenance, and transportable fluids, liquids, and atomized liquid/gas spraying system for the efficient application of liquid materials used to control insect populations, such as mosquito control products.

### BACKGROUND OF THE INVENTION

Traditional methods of spraying and disseminating fluids, liquids, mists, and atomized liquid/gas mixtures found in the prior art generally consisted of thermal smoke generators. Generally speaking, these devices and/or processes involved the creation of a gaseous smoke that serves as a carrier for the selected insecticide, pesticide, water, petroleum or synthetically formulated fluids, to be sprayed by the operator. The use of thermal smoke generators, particularly when mounted on motorized vehicles, can often create visual obstructions and lead to dangerous spraying conditions, especially in residential areas. In addition, the application of the gaseous smoke can be inefficient, uneven, requires large amounts of petroleum products such as diesel or kerosene as the carrier that are harmful to the environment, and can be poorly targeted due to the influence of ambient environmental and weather conditions, such as wind, topography, etc. . . . Such inefficiencies in the application process also result in increased costs in the form of fuel costs and expenses, as well as operator expenses to employ spraying equipment at low speeds over large geographic areas.

More recently, spraying techniques have begun to utilize Cold Aerosol Ultra Low Volume (ULV) generators to disperse insect and mosquito control products for the express purpose of controlling droplet size and dispersion factors in an effort to increase the efficiency of the given application method or process. A sample of such a device or method is set forth in commonly-owned U.S. Pat. No. 7,073,734, incorporated by reference herein. Ultra Low Volume technology provides a light cloud of spray comprising a very specific size of droplet. The use of Ultra Low Volume generators typically allow an efficient delivery of a very specific amount of fluid or chemical to the targeted areas inhabited by insects, such as the mosquito, thereby reducing the amount of fluid chemical required for spraying. Typically, the Ultra Low Volume spray clouds are generated through the use of gas driven blowers, electrically driven rotary sleeves, or even battery supported devices. However, the Ultra Low Volume blowing equipment can produce a significant amount of undesirable emissions and comprise a number of components which need to be maintained and/or calibrated, such as pumps, meters, flow controls, and filtering devices. In this regard, the expense of such equipment is often cost prohibitive to many smaller municipalities, farming operations, agricultural and citrus operators, commercial applicators, law enforcement, military, and/or homeland security personnel, as well as homeowner/development groups that seek to provide specific spraying services to its desired function, citizens, and residents, either in the nature of insecticide eradication or the dissemination of other fluid or atomized substances for various applications.

While these prior art devices can perform well and effectuate the desired dissemination of material, especially mosquito control in many circumstances, they often require a large capital investment to place the equipment into service, utilize a large amount of maintenance resources during operation as well as storage space during periods of non-use, and require additional labor demand to monitor and maintain the systems to ensure that they are in working order when needed. As such, the entity or organization charged with responsibility for the spraying application process is required to devote both financial and technical resources to transportation the multi-component equipment during operation and justify the expenses to its respective constituency, residents, or other recipients of the spraying services.

Moreover, in recent years, state and federal health agencies and organizations in the United States have documented the introduction and spread of a number of viruses and diseases that have been traced to airborne-carrying insects, such as the mosquito. For example, the West Nile Virus and forms of malaria and encephalitis have been identified in both human and animal subjects. In some cases, these viruses have been fatal to humans with children and the elderly being particularly susceptible. At the same time, state and federal environmental legislation and environmental preservation causes have sought protection for “wetlands” areas to preserve the natural environment in designated areas which may be directly adjacent to areas inhabited by human residents. Although preservation of natural resources and the ecosystem are important objectives, a traditional “wetlands” area is generally conducive to the habitation and breeding of large numbers of mosquito populations. Given the airborne and mobile nature of a flying insect, such as the mosquito, the mosquito population often comes into contact with human inhabitants living nearby. In addition additional federal and state regulations covering the dissemination of various chemicals, pesticides, herbicides, and other fluids has required the equipment utilized for ULV cold fogging to become much more sophisticated to accommodate compliance within the regulatory restrictions enforced on the operational entity.

Accordingly, there is need for an improved low-cost system and spraying technique that provides an integrated and dependable application of selected fluid materials to designated geographic areas having increased efficiency not only in dissemination of the material, but at a more efficient and faster application rate designed to maximize coverage area with minimized fuel, transport, and labor costs.

### SUMMARY OF THE INVENTION

The present invention is directed to a spraying system and techniques/methods for the application of fluids, liquids, and atomized liquid/gas materials and a fluid delivery system comprising a centrifugal radial compressor (radial compressor), a power source, a fluid pump, a fluid tank, a control system, and a nozzle is disclosed. The power source powers the radial compressor which introduces a compressed air flow to the nozzle. The pump delivers fluid from the fluid tank to the nozzle where the fluid combines with the compressed air from the radial compressor and is dispersed onto a desired region. The control system monitors and regulates air flow from the radial compressor and fluid flow from the fluid tank.

Radial compressors have many advantages when compared with traditional positive-displacement compressors. Among the advantages, radial compressors have fewer contacting and moving parts, and are energy efficient (radial compressors are typically 50 to 85% efficient in converting input energy to output pressure and air flow compared to 30 to 50% efficiency for positive-displacement compressors, also radial compressors are capable of pressure ranges up to 25 psi (pressure ranges of 4 to 10 psi are preferred to gain maximum efficiency), and provide a greater airflow than a similarly sized positive-displacement compressor. They produce less vibration and harmonic transmission than typical positive displacement compressors and are quieter in energy conversion to pressure and flow of the fluids being utilized. In an idealized sense, the radial compressor achieves a pressure rise and corresponding air flow by adding kinetic-energy/velocity to a continuous uninterrupted air flow entering the impeller. This kinetic energy is then converted to an increase in static pressure by slowing the air flow through a diffuser.

The use of a radial compressor enhances and boosts the efficiency of the spraying process compared to the use of many positive-displacement compressors found in the prior art when applied to targeted portions of the ambient environment, and particularly one for the efficient spraying of selected fluid droplets, such as (without limitation) fluids employing chemical formulations for insect control/eradication, agricultural, citrus, and horticultural applications, herbicide applications, insecticide applications, paint applications, water applications, fertilizer applications, antibiotic applications and application of cleaning, stripping, and even agents having law enforcement, military, and security applications in the area of identifying, controlling, and responding to individuals, crowd situations, and protecting the perimeters of buildings, such as embassies, or other fixed positions from traffic. As such, although it is contemplated that the present invention has particular application and utility in the field of spraying and disseminating formulations and agents to facilitate mosquito and insect control thereby protecting human populations from diseases and pathogens, such as the West Nile Virus, malaria, and various forms of encephalitis, it should be seen that the present invention may also be utilized to deliver formulations and atomized fluid/air mixtures for a wide array of applications, which are not limited to various insects, animal and livestock populations, zoos, food production facilities that utilize live animals, and game preserves. Further, the present invention could be utilized to deliver airborne medical products, vaccines, and antidotes to both human and animal populations in response to a specific medical or epidemiological event.

In a particular preferred embodiment, the radial compressor of the present invention can be part of an overall spraying system or kit which is regulated and controlled to provide efficient fluid droplet size may have fixed or variable flow capabilities, which can be gravity or siphoned fed, and facilitated through the use of at least one nozzle (single or multiple). The nozzle utilized in the present invention may be fed by gravity, siphon, pressure feed, or other pressure fed internal or external mix design. For instance, the present invention may utilize a Venturi-type nozzle, a high-pressure nozzle, siphon or gravity fed air assisted nozzle, air atomizing nozzle, blow-off nozzle, ultrasonic nozzle, thermal nozzle applications and technology, and all other forms of atomizing or spray nozzles. The nozzle of the present invention may or may not have drip characteristics and/or automatic self-cleaning features to reduce the maintenance and clean-up demand depending upon the selected application or spraying environment. Further, the nozzle design of the present invention may incorporate and utilize a variety of patterns such as flat, full cone, hollow cone, fan, etc.

The present invention further serves to provide a method or technique for the application of fluid materials, such as insecticides, pesticides, and herbicides, natural or synthetic, for the reduction and control of mosquito populations, through the use of radial compressor driven spraying kit or set of components which can be mounted and/or transported in the bed of a vehicle or other transportation device. For example, such components could be mounted within a land transportation vehicle or be an integral part of the vehicle, attached to a backpack type configuration for mobile use, or be used as an attachment to conventional lawn and garden equipment, such as a leaf blower, tractor, lawnmower and utility vehicles or the like. The spraying of the droplet particles can be effectuated in accordance with the teachings of U.S. Pat. No. 5,873,530 (“Liquid Atomizing Spray Gun”), WO 99/43441 (“Sprayer For Liquids And Nozzle Insert”), and WO 99/39834 (“Spray Apparatus”), all of which are hereby expressly incorporated by reference. More particularly, the present invention and system employing a radial compressor may achieve atomization of a material selected for application in a wide variety of ways which more efficiently convert input energy to output pressure thereby yielding higher airflow than a similarly sized positive-displacement compressor that is known in the art. It is submitted that this higher airflow and output pressure not only requires less input energy, but would allow a vehicle mounted with such a radial compressor device to travel at relative higher speeds and still effectuate the equivalent coverage of disseminated product and droplet material based upon the higher airflow rates.

These and other objects of the present invention will become apparent upon reading the following detailed description in combination with the accompanying drawings, which depict systems and components that can be used alone or in combination with each other in accordance with the present invention.

### BRIEF DESCRIPTION OF THE DRAWINGS

FIG. 1 is a block diagram of one embodiment of the present invention.

FIG. 2 is a block diagram of a second embodiment of the present invention.

FIG. 3 is a block diagram of a third embodiment of the present invention.

FIG. 4 is a block diagram of a fourth embodiment of the present invention.

FIG. 5 is a drawing of a fifth embodiment of the present invention.

FIG. 6 is a drawing of a sixth embodiment of the present invention.

### DETAILED DESCRIPTION OF THE INVENTION

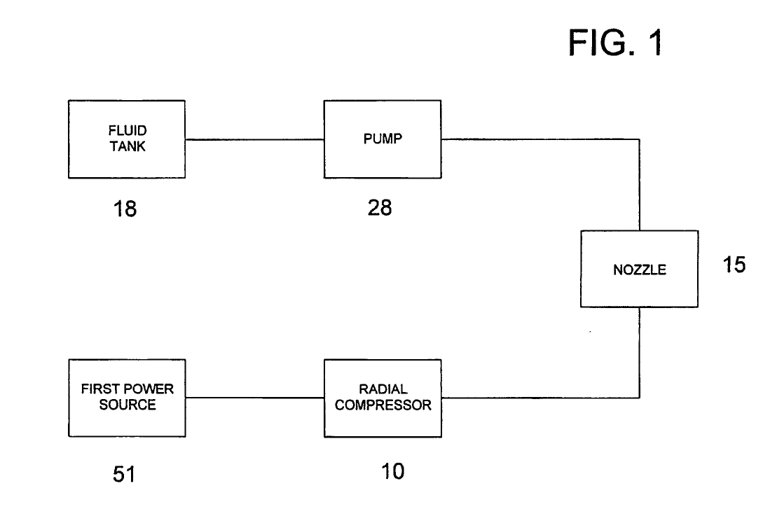

FIG. 1 depicts one embodiment of the fluid delivery system. A first power source 51 provides power to operate a radial compressor 10. The radial compressor 10 directs air flow to a nozzle 15 where it combines with fluid from the fluid tank 18 pumped to the nozzle 15 by a fluid pump 28.

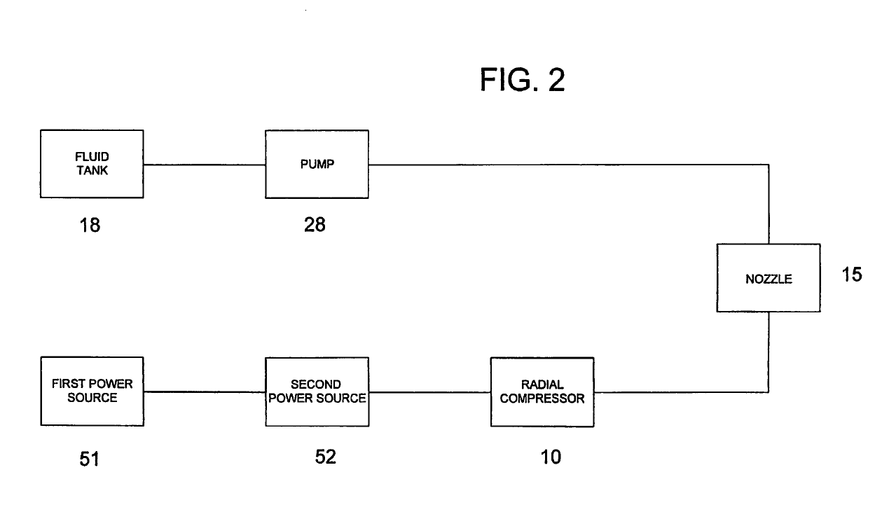

FIG. 2 depicts one embodiment of the fluid delivery system. The first power source 51 operates a second power source 52. The second power source 52 provides a means for torque-speed conversion. This can be accomplished by using, among others, a transmission, gearing reduction/increase, or using different size pulleys on the output shaft of the first power source and input shaft of the radial compressor. Depending on the specifications of the first power source 51 and the radial compressor 10, the second power source 52 can reduce the output RPM from the first power source 51 to a more forceful output to the radial compressor 10, or the second power source 52 can increase the output RPM from the first power source 51 to a less forceful output to the radial compressor 10.

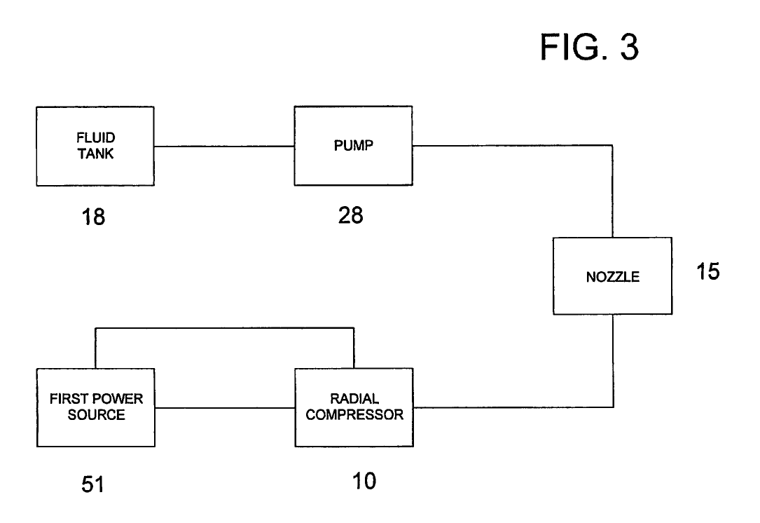

FIG. 3 depicts one embodiment of the fluid delivery system where at least a portion of the air flow generated by the radial compressor 10 is directed into the first power source. The air directed to the first power source 51 can be used to increase the power output of the first power source 51 similarly to a turbocharger increasing the power of an internal combustion engine.

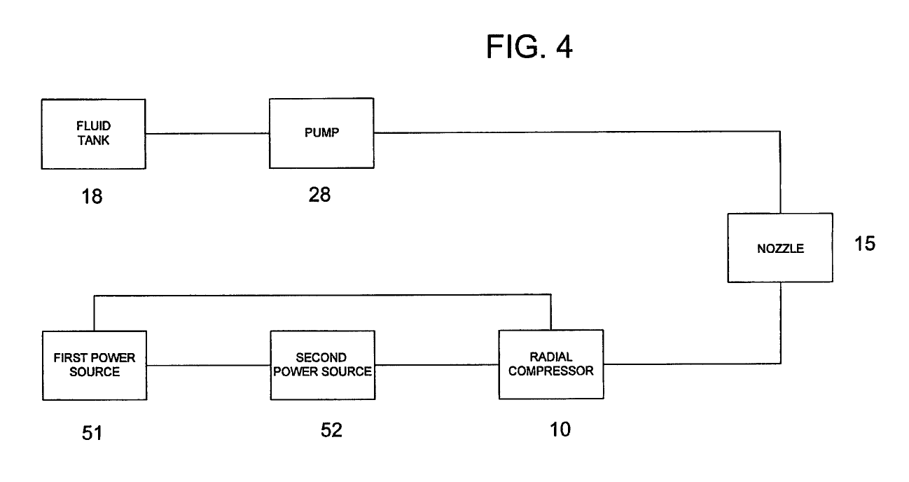

FIG. 4 depicts one embodiment of the fluid delivery system where the second power source 52 is used in conjunction with the air being sent to the first power source 51. The air sent to the first power source 51 by the radial compressor 10 increases the power output of the first power source 51 which in turn increases the power transferred to the second power source for conversion which can, among other things, result in increased RPM at the radial compressor 10.

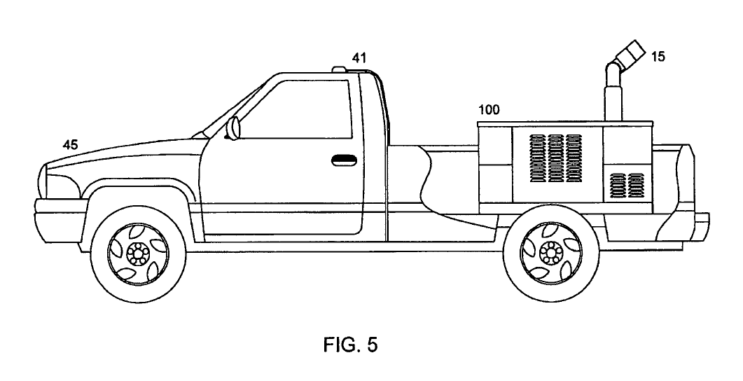

FIG. 5 depicts one embodiment of the fluid delivery system 100 mounted to a truck 45. A GPS antenna 15 is positioned on the top of the vehicle for better reception of a GPS signal. The nozzle 15 of the fluid delivery system extends from the bed of the truck 45.

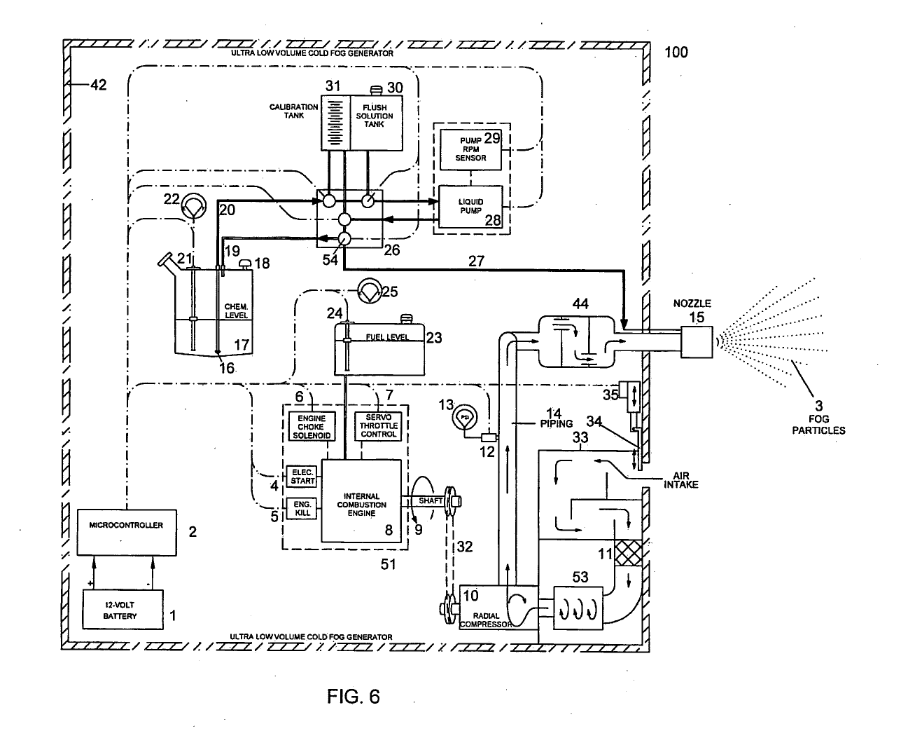

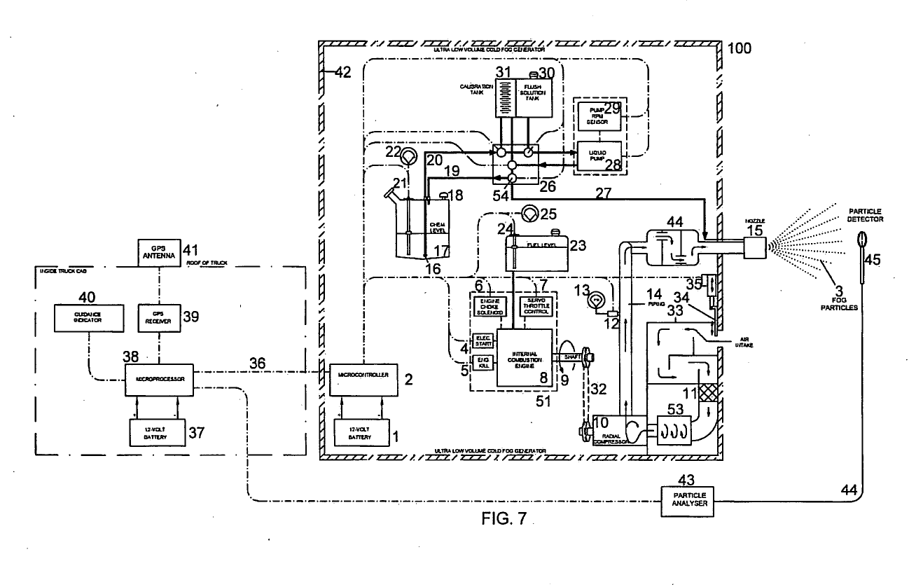

FIG. 6 depicts one embodiment of the fluid delivery system. A power source provides power to operate a radial compressor 10. In FIG. 6, the power source 51 is an internal combustion engine 8 providing power to radial compressor 10 by a rotating shaft 9 and a coupler 32 (the coupler can be a belt, a chain. a gear, or any other means for coupling rotating shaft 9 with the radial compressor 10); other power sources such as electric, hydraulic, air, diesel, solar, and electric, or otherwise may be used to power the radial compressor. The radial compressor 10 is adapted to introduce a compressed air flow to a nozzle 15 through a system of piping 14. The piping 14 can be noise insulated by rubberized material, muffling material, or any other noise dampening material or design characteristics. In addition, before the air travels to nozzle 15, the air can travel through a system of baffles 44 for additional noise dampening. A pressure transducer 12, in communication with a microcontroller 2, measures the radial compressor 10 outlet air pressure. In some conditions, a radial compressor will gulp air at the inlet at which time surging begins to occur on the output side of the radial compressor. These surges are measured by pressure transducer 12 and are transmitted to the microcontroller 2. The microcontroller 2 remedies variations of air flow resulting from the surge or other conditions by either adjusting an air inlet dampener 34 or adjusting the power provided by the power source 8 by, for example, adjusting engine RPM's by adjusting the engine throttle 7, or any combination of the aforesaid.

The radial compressor 10 includes an impeller; the radial compressor produces increased air flow as the impeller rotates faster, providing more air flow and pressure at increased RPM. Radial compressors are very efficient forms of compressors. Benefits of radial compressors over other forms of compressors include being compact, lightweight, quieter operation, increased energy efficiency, and the ability to deliver a high volume of air flow at a low pressure with little vibration. The radial compressor produces air flow through a rapidly rotating impeller that draws air into the center of the housing. Special design characteristics incorporated into the impeller construction allow high efficiency in the generation of pressure, air flow or a combination of both to specifically match the atomization requirements of the fluids being used. A filter 11 can by used on the air inlet side of the radial compressor to remove any impurities that could enter the system. After the air passes through air filter 11, it can travel through a system of spirals 53 that initiates and prepares the air for the rotational movement that the air will experience when the air passes into and through the radial compressor 10. This can help facilitate and improve the flow of air through the radial compressor and the energy input conversion efficiencies of the device.

After drawing molecules into the center of the radial compressor 10, the radial compressor 10 directs the air outward toward and into the housing scroll. The scroll acts as a chamber to collect the air molecules and channel them into the piping 14, so the air can be directed into the nozzle 15. In one embodiment, the diameter of the scroll increases as it moves farther away from the center of the radial compressor, which slows the flow of the air while increasing the pressure of the moving air. The radial compressor compresses the air primarily at the point that the air leaves the impeller and is forced into the scroll; and from there through a shaped bore, preferably a venturi-shaped bore. The compression peaks at the apex (narrowest point) of the shaped-bore before being released into the scroll for discharge. This compression method allows the radial compressor to produce a fairly high degree of thermal efficiency. However, in order to generate substantial amounts of air flow, the impeller must spin at very high rpm. In fact, the amount of air flow produced by a radial compressor is proportional to the square of its impeller speed, enabling the radial compressor to make a substantial amount of air flow.

As shown in FIG. 6, the radial compressor can be mechanically powered by an internal combustion engine, typically by way of a belt, chain-drive, or coupler (direct or indirect) 32 from an engine shaft 9. The belt wraps around a pulley that is connected to the drive gear. The drive gear, in turn, rotates the compressor gear. As shown in FIG. 2, a second power source 52 can be used to increase or decrease the RPM or the torque outputted by the first power source 51. The impeller of the compressor can come in various designs, but its job is to draw air flow in, squeeze the air into a smaller space and discharge it into the nozzle. The specific impeller design provides an increased pressure and air flow or combination thereof as required by the desired atomization characteristics of the fluid being utilized.

In another embodiment, the exhaust gases of an internal combustion engine power the radial compressor. The radial compressor uses the exhaust flow from the engine to spin a turbine at speeds of up to 250,000 RPM, which in turn spins the radial compressor. The exhaust from the engine spins the turbine, which works like a gas turbine engine. The exhaust from the engine passes through the turbine blades, causing the turbine to spin. The more exhaust that goes through the blades, the faster they spin. The turbine is connected by a shaft to the compressor and causes the impeller of the compressor to spin producing air flow into the nozzle 15.

On the other end of the shaft that the turbine is attached to, the radial compressor pumps the compressed air into the air intake of the nozzle. The compressor is a type of centrifugal pump that draws air in at the center of its blades and flings it outward as it spins. In order to handle speeds of up to 250,000 RPM (preference 40,000 to 70,000 RPM), the turbine shaft has to be supported by a bearing; this bearing can be a contact bearing or non contact bearing used to support the shaft and may utilize a thin layer of oil or air that is constantly pumped around the shaft. This serves two purposes: It cools the shaft and some of the other radial compressor parts, and it allows the shaft to spin at high speeds with minimal friction.

When air is compressed, it heats up; and when air heats up, it expands increasing pressure. Therefore, some of the pressure increase from a radial compressor is the result of heating the air before it goes into the air intake of the nozzle. The volume of droplet atomization can be increased by delivering more air molecules into the nozzle, not necessarily more air pressure.

The radial compressor may further compromise an intercooler or charge air cooler. The air flow is cooled as it passes through the intercooler. The intake of air of passes through sealed passageways inside the cooler. The intercooler further increases the air flow density to the nozzle by cooling the pressurized air coming out of the compressor before it goes into the nozzle thereby improving atomization efficiency.

In yet another embodiment, it is contemplated that the compressed air flow exiting the radial compressor can be diverted so that a first portion of the exiting compressed air flow is supplied to the air intake of the nozzle, while a second portion of the compressed air flow is redistributed to the power source powering the radial compressor via a supply line, preferably, an internal combustion engine, through an intake manifold. By forcing more compressed air flow into the intake manifold of the engine and thus into the combustion chamber, better fuel combustion energy is achieved. Accordingly, this additional air flow and fuel utilization makes a normal-sized engine more efficient. The more fuel combustion efficiency that can be derived from the engine means increased horsepower, which can provide for even more air flow exiting the radial compressor and into the air intake of the nozzle. Advantageously, a smaller power source may be used to achieve the required volume output that is needed, which decreases costs and provides a more compact and efficient system.

As mentioned above, an embodiment of the fluid delivery system includes a fluid pump 28. The fluid pump 28 is adapted for introducing a regulated fluid flow. The fluid pump 28 can be controlled by microcontroller 2 so the amount and pressure of the fluid pumped is adjustable. The fluid pump 28 can be monitored by pump RPM sensor 29 which is in communication with the microcontroller 2 for transmitting data to microcontroller 2. Fluid 17 originating from a fluid storage tank 18 enters fluid supply line 20 through filter screen 16. The fluid can then travel into manifold 26 to fluid pump 28. Fluid pump 28 pumps the fluid back into manifold 26. The fluid or a portion thereof can either return back to the fluid storage tank via return pipe 19 or continue to the nozzle 15 through pipe 27. Fluid storage tank 18 may include a gauge 22 for measuring the amount of fluid in the fluid storage tank 18 by fluid level sensor 21. The fluid level sensor is in communication with the microcontroller 2 so that the amount of fluid in fluid storage tank 18 is transmitted to the microcontroller 2.

Manifold 26 houses diverting valves 54 that are controlled by the microcontroller 2. The diverting valves 54 can function to flush the fluid delivery system by introducing flushing solution from flush solution tank 30 into the system instead of fluid from fluid tank 18. A calibration tank 31 can be connected to piping enclosed by the manifold 26. Calibration tank 31 allows for the measurement and adjustment of the content of the fluid 17. The diverting valves 35 can also divert the fluid flow to the nozzle 15 by redirecting the fluid back to the fluid tank 18 instead of to the nozzle 15. The more fluid redirected back to fluid tank 18, the less that flows to the nozzle 15. Once the fluid 17 enters the nozzle 15, it will be introduced to the compressed air where the mixture of the fluid 17 from the fluid pump 28 and the compressed air from the radial compressor 10 form an aerosol 3 that is dispersed from the nozzle 15. The fluid pump 28 may be that of any known in the art including but not limited to a metering pump, piston, gear driven, diaphragm pump, or others. The nozzle 15 may be that of any known in the art including air atomization nozzle, venture nozzle, hvlp (high volume low pressure), or others.

The fluid delivery system further includes the microcontroller 2 powered by a microcontroller power supply 1, in the case of FIG. 6, the microcontroller power supply 1 is a 12-volt battery but can encompass any means for powering the microcontroller such as but not limited to solar, wind, or by power generated by power source 51. The microcontroller 2 controls and monitors the functions of the fluid delivery system. In particularly, the microcontroller 2 may control and monitor the functions of the fluid delivery system by sending and receiving an electrical signals to the fluid pump 28, the fluid pump RPM sensor 29, the diverting valves 54, the fluid level gauge 22 and fluid level sensor 21, the fuel level gauge 25 and fuel level sensor 24 which measure the fuel level in fuel tank 23, the dampening actuator 35 for the air inlet dampener 34, the pressure transducer 12, the internal combustion engine 8 (including a servo throttle control 7, an engine choke solenoid 6, an electric start 4, and engine kill switch 5), or other components and combinations thereof. The microcontroller 2 is adapted to maintain a generally static, (constant), pressure of compressed air exiting the radial compressor 10 and being supplied to the nozzle 15. More specifically, the microcontroller 2 maintains the compressed air flow exiting the radial compressor 10 and entering the nozzle 15 at a generally static pressure whether there is an increase or decrease in the regulated air flow being drawn in by the radial compressor 10 as a result of an increase or decrease in the engine's power output.

In one method of operation as depicted in FIG. 6, a fluid delivery system is provided comprising the internal combustion engine 8 as a power source in communication with a radial compressor 10, a fluid pump 28 adapted for introducing fluid 17, wherein the radial compressor and the fluid pump 28 are in communication with the nozzle 15. The radial compressor 10 is driven by the internal combustion engine 8 to introduce a regulated air flow, by way of a rotating shaft 9. The crankshaft of the internal combustion engine 8 or the exhaust generated by internal combustion engine 8 can also be used, in combinations with or without, to power the radial compressor. The radial compressor 10 compresses the regulated air flow to the nozzle wherein the compressed air is maintained a generally static pressure. Accordingly, the fluid pump 28 introduces a regulated fluid flow to the nozzle 15. Advantageously, the fluid flow and the compressed air flow are merged thereby forming an aerosol 3 that is dispersed by the nozzle 15.

It is contemplated that the compressed air flow to the nozzle 15 can be maintained at a generally static pressure whether there is an increase or decrease of the regulated air flow drawn by the radial compressor 10. This can be accomplished by restricting or dumping air flow to or from the radial compressor 10. In FIG. 6, air flow enters the radial compressor 10 through air box 33. As previously discussed, the air flow entering air box 33 can travel through a system of spirals 53 that initiates and prepares the air for the rotational movement that the air will experience when the air passes through the radial compressor 10. This can help facilitate and improve the flow of air through the radial compressor, thereby improving efficiency. The air entering the air box 33 can pass through an air filter 11 removing impurities before entering the radial compressor 10. Dampening actuator 35 can control the air flowing into inlet air container 33 by controlling the size of the air inlet by covering a portion of the air inlet with the air inlet dampener 34 allowing for better efficiency. The dampening actuator is controlled by the microcontroller 2. The inlet damper 34 allows for a smaller power source to spool up the radial compressor 10. For noise abatement purposes, the air container 33 can be baffled as shown in FIG. 6. By baffling or redirecting the air from the air inlet to the inlet of the radial compressor less noise is produced then a straight air path.

It is further contemplated, that by providing the power source with a portion of the compressed air exiting the radial compressor, the first power source can increase its power output, thereby enabling the radial compressor to draw more regulated air into its housing.

In one embodiment, the fluid delivery system is supported by way of a vehicle 45, preferably a truck. The vehicle 45 is adapted for transporting the fluid delivery device thereby providing a means for efficient dispersion of the fluid output to a spray area. The fluid output being dispersed from the nozzle to the environment includes a fluid volume and an air volume defined by the regulated fluid flow and the regulated compressed air flow through the nozzle.

The regulating of the air flow drawn into the radial compressor, the first portion of compressed air flow to the nozzle, the fluid flow to the nozzle, combinations thereof, or otherwise are controlled by the microcontroller. To control the functions of the fluid delivery device, the microcontroller is in communication with the vehicle, the pump, the first power source, the radial compressor, the nozzle, combinations thereof, or otherwise. The vehicle may further include a user interface to remotely control the fluid delivery system from the cab of the vehicle.

In one exemplary method, the fluid volume to air volume ratio is maintained by regulating the air flow drawn into the radial compressor, the first portion of compressed air flow to the nozzle, the fluid flow to the nozzle, combinations thereof, or otherwise with respect to the speed of the vehicle during the dispersion of the output fluid about a spray area. In particular, the controller will increase, decrease, or maintain the air flow drawn into the radial compressor, the first portion of compressed air flow to the nozzle, the fluid flow to the nozzle, combinations thereof, or otherwise to optimize a regulated dispersion of fluid output. More specifically, the fluid delivery system includes a fluid pump adapted for fluid output, a radial compressor adapted for air intake and output and a nozzle adapted to receive the fluid and air outputs. The fluid and air outputs received by the nozzle may also be regulated by speed of the vehicle carrying the fluid delivery system to allow for variable outputs of atomized fluid output, (e.g. a fluid chemical or otherwise atomized by air), from the nozzle to the environment in relation to vehicle speed. This allows for maintaining proper fluid output to treated air volume, acres or land areas regardless of the speed that the carrying vehicle is going.

The radial compressor fluid delivery system may also comprise a means for noise and heat suppression. This can include noise abatement enclosures, outlet noise suppression, and any other means for reducing the noise and heat produced by the radial compressor fluid delivery system. Means for noise and heat suppression include, but are not limited to, design of the enclosure structure itself, incorporation of materials known in the art that insulate sound and heat, wrapping pipes and tubing with sound and heat insulating materials, muffling and controlling the direction of air flow as well as the intake and output of air. Other mechanical devices such as cooling fans or noise and heat abatement engineering may be incorporated within the overall equipment design to maximize result. The mechanical devices may or may not be controlled by the microcontroller based on the required results. For example, as depicted in FIG. 6, the fluid delivery system 100 is enclosed by noise and heat abatement material 42. The inherit use of a radial compressor reduces the noise produced compared to prior technologies.

As shown in FIG. 7, applicant's radial compressor fluid delivery system also can comprise global positioning system (GPS) technology along with mapping software as disclosed in commonly owned U.S. Pat. No. 7,213,772 for spray delivery system incorporated herein by reference. The GPS technology stores pre-recorded missions in digital memory and upon request retrieves a specific mission among a database of missions. The missions contain directional instructions pertaining to the desired navigational paths so that a driver of the spray vehicle is prompted by the on-board computer when to turn and how fast to drive. In FIG. 7, a GPS receiver communicates geographical coordinates to a microprocessor 38 powered by GPS power source 37, in the case of FIG. 7, the GPS power source 37 is a 12-volt battery. A GPS antenna 41 enhances the reception of the GPS receiver 39. Microprocessor 38 communicates with guidance indicator 40 and also microcontroller 2 by communication link 36. The guidance indicator displays the vehicles location as well as the desired navigational path of the vehicle. Microprocessor 38 is in communication with particle analyzer 43. Particle analyzer 43 is in communication with particle detector 45 through link 44. The aerosol 3 is detected by particle detector 45 and analyzed by particle analyzer 43. Particle analysis data generated by particle analyzer 43 is communicated to microprocessor 38. The particle analysis data is processed by the microprocessor 38 in conjunction with geographical positioning data, vehicle velocity, and mapping software, among others, to determine an efficient navigational path and fluid dispersion rate. A benefit of this approach is spraying a specific area a predetermined amount fluid dispersion as regulated by law. For example, EPA (Environmental Protection Agency) guidelines often mandate how often a treatment or spraying activity can take place; with Applicant's approach, once a specific area has been sprayed with the desired amount, the system can avoid spraying the area for a given period of time by either avoiding the location by navigating around the specific area, or turning spraying nothing (turning off the sprayer) when the specific area is traversed again.

Other embodiments of the fluid delivery system can also comprise a means for compressor cooling (a water cooling channel, among others, can be used to cool the compressor), engine throttle control, and pre-heating of fluid flow to nozzle for enhanced atomization by making the fluid less viscous. Heating the fluid can be accomplished by a heat exchanger from resistance wire heating, exhaust heat, or by utilizing the increased temperature of the output air from the radial compressor.

Some advantages of Applicant's radial compressor fluid delivery system include horsepower to pressure/flow efficiency gains compared to current industrial standards and operational parameters, air flow efficiency gains, enhanced speed of application, and overall device noise abatement reductions compared to the traditional industry. Applicant's radial compressor fluid delivery system can be used to delivery a variety of fluids serving different purposes. For example, Applicant's radial compressor fluid delivery system can be used to apply pesticides, herbicides, fertilizer or any other compound currently used to facilitate the growth and well being of agricultural products such citrus groves. Nebulization can concur for dispersion of chemicals for military use, medical use for both animals and humans.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only three of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiments of the present invention have been disclosed. A person of ordinary skill in the art would realize however, that certain modifications would come within the teachings of this invention. Therefore, the following claims should be studied to determine the true scope and content of the invention.

1. A fluid delivery system, comprising:
a first power source;
a centrifugal radial compressor operatively connected to the first power source, the centrifugal radial compressor capable of compressing a regulated air flow to an elevated pressure;
a fluid tank;
a fluid pump adapted to introduce a regulated fluid flow originating from the fluid tank; and
a nozzle for dispensing a fluid mixture, wherein the nozzle is in communication with the fluid pump for receiving the regulated fluid flow and the centrifugal radial compressor for receiving at least a portion of the compressed air flow.

2. The system of claim 1, wherein the first power source is at least one of or a combination of an internal combustion engine, an electric engine, a hydraulic engine, an air engine, a diesel engine, a steam engine, or an electromagnetic engine.

3. The system of claim 2, wherein the centrifugal radial compressor is driven by a rotating shaft provided by the first power source, an exhaust air flow that is provided by the first power source, or both.

4. The system of claim 2, wherein the first power source includes a driveshaft that drives the centrifugal radial compressor.

5. The system of claim 2, further including a second power source for gear reduction or gear increase that is in communication with the first power source and the centrifugal radial compressor.

6. The system of claim 2, wherein the first power source provides an exhaust air flow that drives the centrifugal radial compressor.

7. The system of claim 2, wherein the first power source receives a second portion of compressed air flow that is supplied by the centrifugal radial compressor, thereby increasing the power output, the exhaust output, or both.

8. The system of claim 1, wherein the centrifugal radial compressor is a dynamic compressor.

9. The system of claim 1, wherein the centrifugal radial compressor is a non-positive displacement compressor.

10. The system of claim 1, further comprising a controller for controlling the centrifugal radial compressor thereby maintaining a generally constant air pressure to the nozzle.

11. The system of claim 1, further comprising a means for suppressing the noise and heat generated by the first power source or the centrifugal radial compressor, or a combination thereof.

12. The system of claim 1, further comprising a water cooling channel for cooling the centrifugal radial compressor.

13. The system of claim 1, wherein the fluid from the fluid tank is preheated.

14. The system of claim 1, further comprising a pressure transducer.

15. The system of claim 1, wherein the fluid delivery system further comprises an inlet damper.

16. A fluid delivery system, comprising:
a centrifugal radial compressor adapted to introduce a compressed air flow from a regulated air flow;
a first power source adapted to provide power to the centrifugal radial compressor;
a pump adapted to introduce a regulated fluid flow;
a nozzle for dispensing a fluid mixture, wherein the nozzle receives the fluid mixture from the pump for receiving the fluid flow and the centrifugal radial compressor for receiving at least a portion of the air flow; and
a controller for maintaining the compressed air flow at a generally static pressure.

17. The system of claim 16, wherein when the regulated air flow entering the centrifugal radial compressor is increased or decreased, the compressed air flow exiting the centrifugal radial compressor and entering the nozzle is maintained at the generally static pressure.

18. The system of claim 16, further comprising a means for noise and heat abatement.

19. A method for fluid delivery using forced induction comprising the steps of:
providing a first power source in communication with a centrifugal radial compressor, and a pump, wherein the centrifugal radial compressor and the pump are in fluid communication with a nozzle;
driving the centrifugal radial compressor using the first power source to introduce an air flow drawn in by the centrifugal radial compressor;
compressing the air flow;
introducing a first portion of compressed air flow to the nozzle;
introducing a fluid flow to the nozzle; and
maintaining the compressed air flow at a generally static pressure, the fluid flow, or both to the nozzle.

20. The method of claim 19, further comprising a step of maintaining the first portion of compressed air flow to the nozzle at the generally static pressure while the air flow introduced by the centrifugal radial compressor is increasing or decreasing.

21. The method of claim 19, further comprising a step of introducing a second portion of compressed air to the first power source for increasing the power output of the first power source.

22. The method of claim 19, wherein the driving step, the centrifugal radial compressor is driven by a rotating shaft, a crankshaft, an exhaust, or combinations thereof of the first power source.

23. The method of claim 19, further comprising a step of regulating the air flow drawn in by the centrifugal radial compressor, the first portion of compressed air flow to the nozzle, the fluid flow to the nozzle, or combinations thereof.

24. The method of claim 23, further comprising a step of providing a vehicle adapted for transporting the fluid delivery system.

25. The method of claim 24, wherein the step of regulating the air flow drawn in by the centrifugal radial compressor, the first portion of compressed air flow to the nozzle, the fluid flow to the nozzle, or combinations thereof are regulated by a controller.

26. The method of claim 25, wherein the controller is in communication with the vehicle, the pump, the first power source, the centrifugal radial compressor, the nozzle, or combinations thereof.

27. The method of claim 19, further comprising a step of dispersing an output fluid from the nozzle to the environment, the output fluid having a fluid volume to air volume ratio.

28. The method of claim 26, further comprising the step of maintaining the fluid volume to air volume ratio by regulating the air flow drawn in by the centrifugal radial compressor, the first portion of compressed air flow to the nozzle, the fluid flow to the nozzle, or combinations thereof based on the speed of the vehicle.

29. The system of claim 19, further comprising a means for noise and heat abatement.
